(19) United States
(12) Patent Application Publication
(10) Pub. No.: US 2006/0261183 A1
(43) Pub. Date: Nov. 23, 2006

(54) ROTOR NOZZLE FOR A CLEANING DEVICE

(76) Inventor: MARTIN F. WIMMER, SHANGHAI (CN)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 11/381,489

(22) Filed: May 3, 2006

(30) Foreign Application Priority Data
May 3, 2005 (EP) 05103677.0-2425

(51) Int. Cl. B05B 3/00; B05B 1/34

(52) U.S. Cl. 239/225.1; 239/380; 239/451

(57) ABSTRACT

A rotor nozzle for a cleaning device, specifically for a high-pressure cleaning device. The device comprises at least one housing with a feeding duct and an outlet for the passage of a fluid. Within the housing, there is a nozzle body, traversed by the fluid, and rotated thereby about a given axis within housing. According to the invention, the nozzle body is supported at one end by a bearing arranged within the housing. Further, at least one part of the nozzle body's outer mantle is in contact with the housing's inside surface. The bearing supporting the nozzle body is based on a cylindrical bearing which is incorporated into the housing. On the bearing there is a raised area which is concentrically arranged around the outlet and is turned toward the housing's interior. The nozzle body itself has a sliding surface substantially extended around the nozzle body. The sliding surface is concave and adapted to receive at least a portion of the bearing in a ball-and-socket-type fashion. This connection between the sliding surface of the nozzle and the bearing allows the nozzle to rotate around the bearing with minimal friction.

This application claims the priority of European patent application number 05103677.0-2425 PCT tilted “Rotorduese fuer ein Reinigungsgeraet” filed May 3, 2005.

### BACKGROUND OF THE INVENTION

The present invention concerns a rotor nozzle for a cleaning device, particularly a high-pressure cleaning device. The invention also discloses a method of using a rotor nozzle in a cleaning device, specifically in a high-pressure cleaning device

Rotor nozzles for cleaning devices are known in the state of the art. The patent EP 0 600 937 B1, for instance, discloses a rotor nozzle for a high-pressure cleaning device, the nozzle of which is incorporated in a housing, i.e. in a pan-shaped bearing situated in the housing's outlet area, the nozzle abutting its upper part via braking members against the inside wall of the housing. However, it is disadvantageous in that it is rather complicated and thus expensive, not only to place the nozzle body in the outlet area, but also to abut it via braking members against the rotor housing.

The German utility model DE 200 22 303 U1 also discloses a rotor nozzle for a cleaning device, wherein the fluid, after being introduced tangentially into the rotor nozzle's housing, forms a rotating fluid column. While rotating about the longitudinal axis the column drags along the nozzle body, therefore rotating along the cone envelope inside the housing. In this invention, the nozzle body is contained in the front part of a pan-shaped bearing which also contains an opening passage for the fluid, the nozzle body's upper part being based on a sliding ring.

The European patent EP 1 305 079 A1 refers to a rotor nozzle for cleaning devices as well. The nozzle body is situated in a housing and the fluid stream rotates freely around a given axis within the housing. The nozzle is based on a supporting bolt placed in the housing's recess.

The publicly distributed printed copy of the German application DE 42 20 561 discloses a rotor nozzle for high-pressure cleaning devices, wherein the nozzle body is situated in a housing. The nozzle is placed on a bearing head which is placed in a seat and rotates freely around its longitudinal axis.

Based on the state of the art, the problem to be solved was to create such a rotor nozzle, simply structured and specifically such that it could easily be used. Furthermore, the present invention solves the problem of making a nozzle body, where the used nozzles can easily be modified or replaced so the nozzle body can specially be adapted to different uses in such a way that the fluid jet at the nozzle body's outlet passage can be remodeled in order to adapt it to the user's needs.

The object of the invention is accomplished in accordance with claim 1. Preferred embodiments of the invention are the subject-matter of the sub-claims. Furthermore, the problem is solved by the use of the invention's rotor nozzle in a cleaning device.

### SUMMARY OF THE INVENTION

The present invention is a rotor nozzle for a cleaning device, specifically for a high-pressure cleaning device. The device comprises at least one housing with a feeding duct and an outlet for the passage of a fluid. Within the housing, there is a nozzle body, traversed by the fluid, and rotated thereby about a given axis within housing. According to the invention, the nozzle body is supported at one end by a bearing arranged within the housing. Further, at least one part of the nozzle body's outer mantle is in contact with the housing's inside surface. The bearing supporting the nozzle body is based on a cylindrical bearing which is incorporated into the housing. On the bearing there is a raised area which is concentrically arranged around the outlet and is turned toward the housing's interior. The nozzle body itself has a sliding surface substantially extended around the nozzle body. The sliding surface is concave and adapted to receive at least a portion of the bearing in a ball-and-socket-type fashion. This connection between the sliding surface of the nozzle and the bearing allows the nozzle to rotate around the bearing with minimal friction.

### BRIEF DESCRIPTION OF THE DRAWING

FIG. 1 is a sectional view of an embodiment of the invention showing the nozzle inside of the housing;

FIG. 2 is a sectional view of an embodiment of the invention showing the nozzle without the housing;

FIG. 3 is a is a sectional view of the annular member; and

FIG. 4 is a sectional view of an embodiment of the invention without the housing wherein the nozzle jet does not extend below the sliding surface.

### DESCRIPTION OF THE PREFERRED EMBODIMENTS OF THE INVENTION

The present invention is a rotor nozzle for a cleaning device, specifically for a high-pressure cleaning device. According to one preferred embodiment of the invention, the nozzle body's 11 sliding surface 21 and the bearing's surface 20 shape are substantially adapted and adjusted to one another. In this embodiment, the sliding surface 21 is generally concave while the bearing's surface 20 is generally convex so that a portion of the sliding surface 21 receives a portion of the bearing's surface 20 and creates a seal where the sliding surface 21 and bearing's surface 20 meet. Preferably, the radius of curvature of the bearing's surface 20 is slightly different than the radius of curvature of the sliding surface 21 so that the surface area of the bearing 9 contacting the sliding surface 21 is minimized to reduce friction.

According to another preferred embodiment, a raised area forms a bearing 9 surface, which is at least partially carried out in a spherical, parabolic or elliptic shape or in combinations thereof and the like.

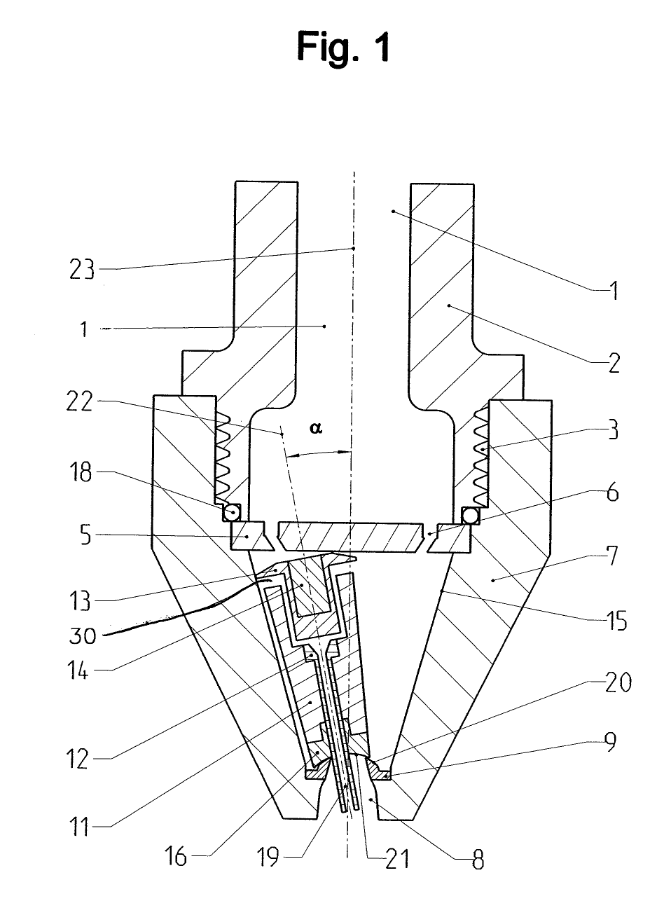

According to another preferred embodiment of the invention, the bearing 9 has a recess that is arranged substantially concentrically around the housing's fluid outlet. It is not required that the fluid of the cleaning device flow directly through the bearing's 9 recess, however, the recess should include at least a part of the nozzle 12 situated inside the nozzle body 11. According to another preferred embodiment, the nozzle 12 is arranged along an axis inside the nozzle body 11 and penetrates the bearing's 9 recess over a predetermined length as shown in FIG. 1. The extension of the nozzle 12 into the bearing's 9 recess helps to prevent the fluid from hitting the lower portion of the housing hood 7 as it exits the nozzle 12.

According to another preferred embodiment shown in FIG. 4, the nozzle 12 does not penetrate into the bearing's 9 recess; however, in this embodiment, the nozzle 12 comprises a larger bore that feeds into a smaller bore. This double bore configuration helps to direct the fluid into a more focused stream so that it does not hit the lower portion of the housing hood 7 as it exits the nozzle 12.

According to another preferred embodiment, the bearing 9 is shaped as a removable insert of the housing. Among others, this has the advantage that in cases of high wear, the bearing 9 itself can be exchanged without having to exchange the whole rotor nozzle.

According to another preferred embodiment, a part of the bearing's 9 surface inside the housing can have a spherical shape such that the central point of the spherically shaped surface is situated on the bearing's 9 central axis, preferably at a radius between the center and the surface of 3 mm to 15 mm, more preferably at a radius of 5 mm to 10 mm.

According to another preferred embodiment, the aperture angle between the nozzle body's 11 rotation axis 22 and the nozzle body's 11 sliding surface 21 is between 110° and 150°, especially between 120° and 140°. This aperture angle is obtained through the fact that in this embodiment the sliding surface's 21 cross-section is truncated-cone-shaped and that the angles between its lateral legs and the rotation axis 22 are the ones mentioned above.

It goes without saying that as a result of the sliding surface's 21 form, the bearing 9 inside the housing is made such that the optimum support of the nozzle body 11 is maximized.

Thus, the wear and the friction between the moving and static elements can be reduced. A sufficient sealing between the bearing 9 inside the housing, the nozzle head, and the sliding surface 21 can be obtained to prevent fluid from exiting the device between the nozzle and the bearing 9. This sealing effect can be attributed either to a big supporting surface or to a linear shaped contact surface between the sliding surface 21 and the bearing 9 surface.

According to another preferred embodiment, the sliding surface 21 is ball-shaped with a radius of about 3 mm to 17 mm, its radius must necessarily exceed that of the bearing 9 surface to minimize friction.

According to a preferred embodiment, the housing includes at least one housing hood 7 and at least one housing footing 2. The feeding duct 1 for the fluid is preferably arranged in the footing 2. In the housing hood 7 there is a cylindrical base of the bearing 9 which includes the recess and the raised bearing seat. According to a preferred embodiment, the rotor nozzle's housing may be made of a at least one material belonging to the group of polyamides, polyacrylates, metals, composite materials, such as fiber reinforced plastic materials, polyamides containing a given percentage of glass fiber or combinations thereof, and the like.

According to another preferred embodiment, the nozzle body 11 has a substantially cylindrical or conical shape, and is the preferred seat of the exchangeable nozzle 12.

According to another preferred embodiment, the nozzle 12 length is chosen such that its outlet end is situated within the arc of a circle having a diameter between 0.1 mm and 6 mm, preferably of 3 mm. The arc of the circle being arranged around the intersection between the nozzle's body 11 and the housing's middle axis 23.

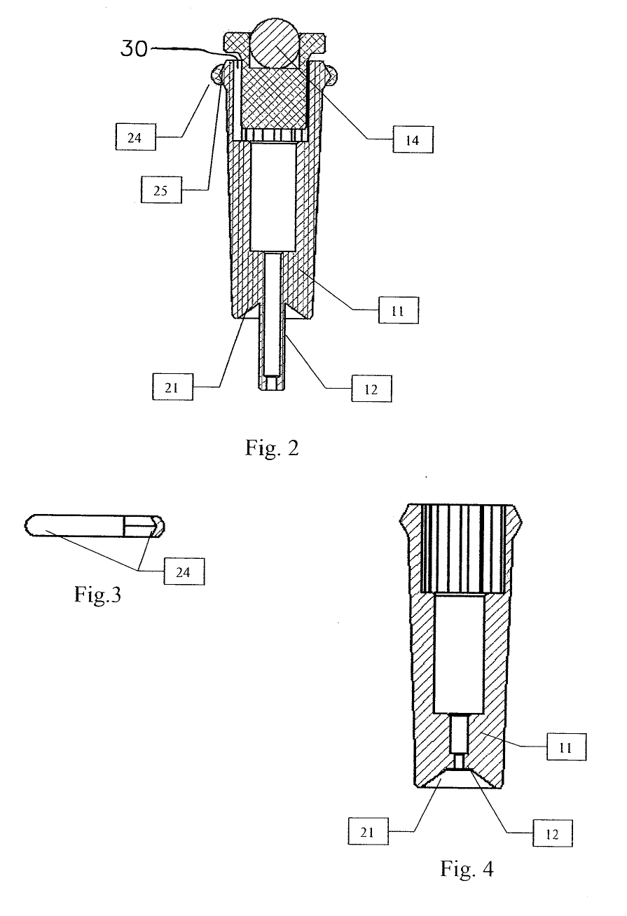

According to a preferred embodiment, the nozzle body's 11 sliding surface 21 forms a separate insert 16, arranged on the nozzle. This insert is made preferably of materials such as wear-resistant ceramics, composite ceramic materials, materials containing at least one ceramic component, synthetic materials, such as polyether ketones, combinations thereof and the like. The nozzle body 11 is preferably produced with a two part mold where the dividing line of the mold is around the circle plane indicated by reference number 25 in FIG. 2. The two adherent surfaces form an angle which is adapted to receive an annular member 24, as is further described below. The radius of the annular member 24 forms a roller body 13 (further described below), which abuts against, or rolls along, the housing's interior wall 15 as the nozzle is rotated inside the housing. If the annular member 24 becomes worn out due to friction between the annular member 24 and the housing inner surface 15 as the nozzle rotates, the annular member 24 can be replaced without having to replace the entire nozzle.

One of the subject-matters of the present invention is the fact that the nozzle body 11 insert 16 is not completely made from the above-mentioned materials, but only the sliding surfaces 21 of the nozzle body 11 or the insert 16, in such a way that the friction can be reduced to a very low level. The same is true of the housing's bearing 9 and/or the housing's bearing surface 20. In other words, the components of this invention may have coatings on their outer surfaces to reduce friction.

According to the invention, the connection between the nozzle body 11, the insert 16, the bearing 9, and/or housing may be detachable, though there may also be an interlocking, a frictional and/or a bonding connection.

According to another preferred embodiment, the nozzle body's 11 upper end is formed by a roller body 13 arranged in such a way that the cleaning fluid can flow into the nozzle body 11 through the side-channels 30. The roller body 13 has an outer radius that abuts against, or rolls along, the housing's interior wall 15 as the nozzle is rotated inside the housing. In this connection, and according to another embodiment, at least a part of the roller body 13 consists of a material reducing the wear on the housing's interior 15 to a minimum. This material can be ebonite or something similar.

As seen in FIG. 2, the roller body 13 may be annular member 24. Annular member 24 is shown in FIGS. 2 and 3 by reference number 24. Annular member 24 is comprised of rubber or some similar material so that it has an opening in its middle. The annular member 24 may be round, oval, square, or rectangular as long as it has an opening in its middle. The preferred shape of the member 24 is annular, which is meant to include both a round and an oval shape. The annular member 24 has an interior portion that is V-shaped or concave. In the preferred embodiment, the angle of the concave inner surface is less than 180 degrees, and more preferrably the angle is between 140 and 100 degrees.

The concave interior portion of the annular member 24 is adapted to fit over a generally convex protrusion on an article. Preferrably, the distance from the center of the radius of the concave portion to the outer contact point of the protrusion on the article is shorter than the radius of the annular surface. If this distance is not shorter than the radius of the annular surface, the annular member 24 may not be held against the article with the proper amount of force.

In the present invention, the concave interior portion of the annular member 24 is adapted to fit over a protrusion on the nozzle body 11, as seen in FIG. 2. The annular member 24 then makes contact with and rolls along the housing's interior wall 15 as the nozzle is rotated inside the housing. However, the use of the annular member 24 is not limited to the nozzle of the present invention. For example, the annular member 24 may take the place of traditional o-rings by being used as a sealing member. The annular member 24 is beneficial over traditional o-ring seals because traditional o-ring seals require a groove to be machined into the part that is adapted to reccieve the o-ring. Machining these grooves can be very expensive and time consuming. The annular member 24 of the present invention is therefore beneificial because it does not require the machining of a groove, rather, its groove is placed over a protrusion on the part to be sealed.

According to another embodiment, the roller body 13 has a recess in which a weighted body 14 is inserted, preferably in an interlocking manner. Preferably the weighted body 14 is made from brass or a similar material and helps adapting the nozzle body's 11 mass to the respective needs. FIG. 1 shows the weighted body 14 as a cylindrdically shaped object. As seen in FIG. 2, the weighted body 14 can also have a rounded or ball shape. In alternate embodiments, the weighted body 14 can have any other suitable shape.

The invention also discloses a method of using a rotor nozzle according to one of the above-mentioned embodiments, i.g.for a cleaning device, especially for a high-pressure cleaning device such as the ones known in the state of the art, for instance mobile high-pressure cleaners or car-washes meant for passenger cars or trucks.

Below, the invention is described in the light of an illustrative embodiment. However it is emphasized that this embodiment is not meant to limit the scope of the invention. Modifications or adapations, etc. of bearings 9, bearing surfaces 20, sliding surfaces 21, and so on are supported by the present invention.

For instance, FIG. 1 shows a sectional view of the rotor nozzle in a possible embodiment according to the invention. According to this embodiment, the cleaning fluid, (such as water with or without additives) is let into the rotor nozzle through the feeding duct 1. The cleaning substance streams through the plate's 5 opening 6 and into the housing's conical inner section. The fluid then passes through the nozzle body's 11 openings 30 to the nozzle jet 12 and leaves the rotor nozzle via the nozzle's mouth and/or the rotor nozzle's outlet 8. Preferably, the nozzle's length is chosen such that the nozzle's jet 12 is situated within the rotor nozzle's outlet 8. As discussed above, this helps prevent fluid from hitting the lower portion of the housing hood as it exits the nozzle 12. In an alternate embodiment show in FIG. 4, the nozzle jet 12 does not extend below the sliding surface 21 and into the rotor nozzle's outlet 8. In this embodiment, the nozzle 12 comprises a larger bore that feeds into a smaller bore. This double bore configuration helps to direct the fluid into a more focused stream so that it does not hit the lower portion of the housing hood 7 as it exits the nozzle 12.

The rotor nozzle housing preferrably comprises a housing hood 7 in which the nozzle outlet 8 is arranged and a housing footing 2 in which the feeding duct 1 is arranged. As seen in FIG. 1, the housing footing 2 is connected to the housing hood 7 by a screwed connection 3 and has a seal element 18, preferably an O-ring seal. It follows that the sealing can take place in all other ways known from the state of the art.

Between the housing footing 2 and the housing hood 7 there is a nozzle plate 5 showing at least one passage 6, through which the fluid, when being fed through duct 1 into the rotation nozzle, flows into the rotation nozzle's conical inner section. In this embodiment, the openings 6 in the nozzle plate 5 are made such that the fluid enters the conus-shaped rotor nozzle's interior at a given angle. As a consequence, the nozzle body 11 along with the nozzle 12 is put into motion, preferably into rotation. The nozzle body 11 rotates along the conical housing's 7 inner surface 15 about the axis 23. At the same time the nozzle body 11 also rotates about its own rotation axis 22. The intersection between the nozzle body's 11 rotation axis and the housing hood's 7 middle axis 23 is indicated by reference number 19.

According to an embodiment of the present invention, the size of the jet circle described by the rotating nozzle can be determined with the help of the angle α, as shown in FIG. 1. Angle α is formed between the central axis 23 and the rotation axis 22. There are a number of different ways in which to change angle α. By doing this, it is possible to define its field of application, for instance as either a “dirtblaster” or a “pressure-washer”. For example, changing angle α may simplify the cleaning of larger surfaces since, due to the jet's rotation, the surface aread treated can be made bigger.

As best seen in FIG. 1, the nozzle body 11 further has a sliding surface 21, which according to the present invention, is shaped like a section of a spherical surface. This sliding surface is supported by the bearing 9, the surface 20 of which also has the same substantially spherical surface section shape.

According to a preferred embodiment, the spherical section's diameters of the sliding and the bearing surfaces 20 can differ from one another, the nozzle body's 11 sliding surface 21 being preferably a bit larger than that of the bearing 9.

According to another preferred embodiment, the sliding surface's 21 conical opening has an opening angle between 100° and 150°, preferably between 120° and 140.

According to the present embodiment, the nozzle's 12 mouth is situated in the nozzle housing's outlet area 8. However, in an alternate embodiment shown in FIG. 4, the nozzle 12 does not extend below the sliding surface 21 and into the nozzle housing's outliet area 8. In this embodiment, the nozzle 12 comprises a larger bore that feeds into a smaller bore. This double bore configuration helps to direct the fluid into a more focused stream so that it does not hit the lower portion of the housing hood 7 as it exits the nozzle 12.

According to this embodiment, the nozzle body has an exchangeable insert 16, which preferably made from a material other than the one used for the nozzle body 11. Therefore the region between the sliding surface 21 and the bearing surface 20 can be made in such a way that it is more resistant against the extremely high mechanical stress caused by the relatively high differential speed occuring between the sliding surface 21 and the bearing surfaces 20 during operation.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included within the scope of the following claims.

What is claimed is as follows:

1. A rotor nozzle for a cleaning device, specifically for a high-pressure cleaning device with at least one housing (2,7), a feeding duct (1), an outlet (8) for fluid, as well as a nozzle body (11) contained in the housing and traversed by the fluid, and rotated thereby about a given axis of the housing, supported at one end by a bearing (9) arranged within the housing with a central recess, at least one part of the nozzle body's (11) outer mantle being in contact with the housing's inside surface,
wherein
the bearing (9) supporting the nozzle body (11) is formed by a raised area arranged concentrically around the outlet and in such a way that the nozzle body has a sliding surface (21), which is arranged substantially concentrically around the nozzle body's nozzle and accommodating, at least partially, a bearing surface (20) of the bearing (9).

2. A rotor nozzle according to claim 1,
wherein
the raised area (9) forms the bearing surface (20) which at least section-wise is executed in a spherical, parabolic or elliptic shape or combinations thereof and the like.

3. A rotor nozzle according to claim 1
wherein
the bearing's (9) recess is arranged substantially concentrically around the housing's fluid outlet (8).

4. A rotor nozzle according to claim 1
wherein
the nozzle body (11) contains an axially arranged nozzle (12) which penetrates the bearing's (9) recess over a given length.

5. A rotor nozzle according to claim 1
wherein
the bearing's (9) surface (20) is spherically shaped and arranged in such a way that its central point is situated on the housing's (2,7) central axis and preferably has a radius of between 3 and 15 mm, especially between 5 and 10 mm.

6. A rotor nozzle according to claim 1
wherein
the nozzle body's (11) sliding surface (21) and the bearing's surface (20) shape are substantially adapted to one another.

7. A rotor nozzle according to claim 1
further comprising an aperture angle between the nozzle body's (11) rotation axis (22) and the nozzle body's sliding surface (21), wherein the aperture angle is between 110° and 150°, especially between 120° and 140°.

8. A rotor nozzle according to claim 1
wherein
the sliding surface (21) has a radius of between 3 and 17 mm and in particular is greater than the bearing's surface (20) radius.

9. A rotor nozzle according to claim 1
wherein
the housing (7,2) contains at least one of the materials belonging to the group of polyamides, polyacrylates, metals, composite materials, such as fiber reinforced plastic materials, polyamides containing a given percentage of glass fiber or combinations thereof, and the like.

10. A rotor nozzle according to claim 1
wherein
the housing has a housing hood (7) in which the outlet (8) is arranged and at least one housing footing (2) in which the feeding duct (1) is arranged; and
wherein the outlet (8) is arranged at the raised bearing's (9) level.

11. A rotor nozzle according to claim 1
wherein
the substantially cylindrical shape or substantially conical nozzle body (11) is provided with an exchangeable nozzle (12).

12. A rotor nozzle according to claim 1
wherein the housing hood (7) has a middle axis (23); and
wherein the nozzle (12) has a protruding end that is between 2 mm and 19 mm long and is specifically chosen such that the nozzle's end lies within the arc of the circle formed around the intersection (19) between the nozzle body's (11) rotation axis and the housing hood's (7) middle axis (23), the arc of the circle having a diameter of between 0.1 mm and 6 mm, preferably of about 3 mm.

13. A rotor nozzle according to claim 1
wherein
the nozzle body (11) has an insert (16), the end of which substantially forms the sliding surface (21) of the nozzle body.

14. A rotor nozzle according to claim 1
wherein
at least the nozzle body's (11) insert (16) or at least the nozzle body's (11) sliding surface (21) are partially made of materials such as wear-resistant ceramics, composite ceramic materials, at least one ceramic component, synthetic materials, such as polyether ketones, combinations thereof and the like.

15. A rotor nozzle according to claim 1
wherein
the bearing (9) and the bearing surface (20) are removable from the housing hood (7).

16. A rotor nozzle according to claim 1
wherein
the housing hood's (7) bearing (9) or the bearing's (9) surface (20) are partially made of resources containing materials such as wear-resistant ceramics, composite ceramic materials, at least one ceramic component, synthetic materials, such as polyether ketones, combinations thereof and the like.

17. A rotor nozzle according to claim 1
wherein the nozzle body (11) has an upper end; and
wherein at the nozzle body's (11) upper end a roller body (13) is inserted in such a way that the cleaning fluid can flow into the nozzle body (11) through the side-channels (30) and that the roller body's (13) outer radius forms a contact surface supporting the nozzle body (11) from the housing's inside (15).

18. A rotor nozzle according to claim 1
wherein
the rolling body (13) is made of a material reducing the housing's (7) wear on the inside, preferably made of ebonite.

19. A rotor nozzle according to claim 18
wherein
the rolling body (13) has a cylindrical recess, into which a body, preferably cylindrical and preferably made of brass, the mass of which is defined by its length, radius and its relative density (14), is inserted in an interlocking manner.

20. The use of a rotor nozzle according to claim 1 for a cleaning device, specifically for a high-pressure cleaning device.

21. The use of a rotor nozzle according to claim 1 for an automated cleaning conveyor belt line, specifically for a car-wash meant for passenger cars or trucks.

22. An annular member having an interior surface with a concave shape wherein the concave shape of the interior surface is adapted to fit over a protrusion on an article to be sealed.

23. The annular member of claim 22 wherein the concave shape is a V-shape.

24. The annular member of claim 23 wherein the V-shape has an angle less than 180 degrees.

25. The annular member of claim 22 wherein the concave inner portion has a radius and the protrusion on the article to be sealed has an outer contact point; and wherein distance from the center of the radius of the concave portion to the outer contact point of protrusion on the article to be sealed is shorter than the radius of the annular surface.

26. A rotor nozzle for a cleaning device, said rotor nozzle comprising:
a housing having a feeding duct adapted to receive fluid and an outlet adapted to expel fluid;
a nozzle body contained in the housing so that at least a portion of the nozzle body is in contact with the inside surface of the housing, wherein the nozzle body is traversed by the fluid so that the nozzle body is rotated thereby about a given axis of the housing;
a bearing combined with the housing so that it supports at least a portion of the nozzle body, wherein the bearing is formed by a raised area arranged concentrically around the outlet and in such a way that the nozzle body has a sliding surface which is arranged substantially concentrically around a portion of the nozzle body.

27. The rotor nozzle of claim 26 wherein the bearing is detachable so that it can be replaced when it gets worn out.

28. The rotor nozzle of claim 26 further comprising a detachable insert combined with a portion of the nozzle.

29. The rotor nozzle of claim 26 wherein the sliding surface is detachable so that it can be replaced when it gets worn out.

30. The rotor nozzle of claim 26 wherein a seal is created between the nozzle and the bearing.

31. The rotor nozzle of claim 26 wherein the nozzle body has an axis and the nozzle body is rotated around its axis as well as around the axis of the rotor nozzle.

32. The rotor nozzle of claim 26 wherein the nozzle and sliding surface are comprised of all one part.

33. The rotor nozzle of claim 26 wherein the nozzle body is formed by a two-part mold so that the entire nozzle is all one part.

34. The rotor nozzle of claim 26 wherein the nozzle body further comprises a nozzle jet.

35. The rotor nozzle of claim 34 wherein the nozzle jet extends into the outlet.

36. The rotor nozzle of claim 34 wherein the nozzle jet does not extend into the outlet.

37. The rotor nozzle of claim 34 wherein the nozzle jet comprises a larger bore located upstream from a smaller bore to aid in directing the fluid into a more focused stream as it is expelled from the nozzle.

38. A rotor nozzle for a cleaning device, said rotor nozzle comprising:
a housing having a feeding duct adapted to receive fluid and an outlet adapted to expel fluid;
a nozzle body contained in the housing so that at least a portion of the nozzle body is in contact with the inside surface of the housing, wherein the nozzle body is traversed by the fluid so that the nozzle body is rotated thereby about a given axis of the housing;
a bearing combined with the housing so that it contacts a portion of the nozzle, wherein the bearing is generally convex and the portion of the nozzle contacting the bearing is generally concave so that a portion of the bearing receives and creates a seal with a portion of the bearing.
